(19) United States
(12) Patent Application Publication
(10) Pub. No.: US 2024/0291651 A1
(43) Pub. Date: Aug. 29, 2024

(54) EMBEDDED DATA HARVESTING

(71) Applicant: RIDDLE & CODE GMBH, Wien (AT)

(72) Inventors: Thomas FÜRSTNER, Malta (MT); Alexander KOPPEL, Perchtoldsdorf (AT); Cao MINH, Wien (AT)

(21) Appl. No.: 18/573,778

(22) PCT Filed: Jun. 22, 2021
(86) PCT No.: PCT/EP2021/067020

§ 371 Date: Dec. 22, 2023

(51) Int. Cl. H04L 9/08; H04L 9/32

(52) U.S. Cl. CPC H04L 9/088; H04L 9/3247

(57) ABSTRACT

System and method for securely distributing data collected by an embedded trusted device, the method comprising: receiving by the embedded trusted device at least one data point from a connected data source; computing a cryptographic hash of the at least one data point; computing by the embedded trusted device a digital signature of the at least one data point with a first cryptographic private key stored in the embedded trusted device; transmitting a first record comprising at least the cryptographic hash or the digital signature to a public transaction repository; transmitting the at least one data point to a data consumer having a second cryptographic private key, responsive to verifying a second record cryptographically associated with the first cryptographic private key and the second cryptographic private key.

The present invention concerns a method for securely distributing data collected by an embedded trusted device and it concerns a system for securely distributing data generated by at least one data source.

Today, many devices and machines capture and operate on large amounts of data. One example is cars. Modern cars are packed with all types of sensors to monitor not only the operation of the car itself, but also the passengers and the environment of the car. This development is furthered by the trend to more and more autonomous operation of the car. Another example are household appliances or generally smart home appliances, ranging from washing machines monitoring the weight of textiles and usage of water, to heating controls and lighting controls monitoring the presence of residents in their daytime- and weather-dependent preferences. The same is true for commercial or industrial appliances and applications—perhaps to an even greater extent.

The data available to these devices and machines is usually discarded or kept locally for short amounts of time, for privacy and often legal reasons. Usually, the owner or operator of the device would need to consent to a collection or even sharing of data produced by their devices. There is no incentive for them to provide this consent on an individual basis. On the other hand, the data would be of significant value, if it could be obtained on a collective basis. However, this value would be lost if the data were fully or partially forged, manipulated or generally inauthentic.

In order to harness the technological and economic benefits of learning from existing, but yet an accessible data, there is a need to solve the above problems. A solution needs to provide means for securely and unambiguously attributing data to a-potentially anonymous-source, which can then be incentivised to provide access to its data; and means for guaranteeing authenticity of the data provided by the source.

One approach to solve these problems is disclosed in CN 109741074 A. This prior art describes a blockchain system based on vehicle data. The data is collected by an embedded device in the vehicle, encrypted and transmitted to the blockchain network. The embedded device may be an existing on-board diagnostics equipment. The upload to the blockchain network is provided through a smart terminal, such as a mobile phone of the car owner. The system has several drawbacks and shortcomings. The fact that the data is encrypted does not in itself provide any indication of its authenticity. It is unclear, whether different sources use different encryption keys and how the encryption keys are obtained, distributed and secured or stored. The system requires direct key exchange between the data source and the receiver. Apart from being complicated and difficult to implement securely, such direct key exchange potentially reveals the identity of the data source or else fails to evidence the authenticity of the data. Moreover, the system lacks technical support for a continuous incentive for the data source to provide data access. Once the decryption key is shared, the data source or all data sources lose(s) control over the access permissions.

Some of the problems mentioned above are avoided by the system disclosed in US 2020/0058023 A1. However, this system is not applicable to the field of collecting data from devices and machines. It requires a notary instance with direct access to ground truth data for authenticating the data provided by a data seller. In the example of this prior art, the data seller may provide data related to their bank account and the bank managing their account may act as notary attesting to a data buyer the accuracy of the provided data—to which the bank obviously has direct access.

The problem of acquiring verifiable and accurate information in a vehicle is tackled by U.S. Pat. No. 10,950,067 B2. However, this prior art does not contain any workable disclosure touching on the problems of exchanging the data and incentivising the data collection and sharing mentioned above. The use of a blockchain and ledger capabilities are merely abstractly mentioned. The disclosure lacks information on the implementation of such a system.

It is an object of the present invention to provide a method and system as defined in the outset that overcomes at least some of the drawbacks and shortcomings of the prior art.

The method of the present disclosure for securely distributing data collected by an embedded trusted device comprises: receiving by the embedded trusted device at least one data point from a connected data source; computing a cryptographic hash of the at least one data point; computing by the embedded trusted device a digital signature of the at least one data point with a first cryptographic private key stored in the embedded trusted device; transmitting a first record comprising at least the cryptographic hash or the digital signature to a public transaction repository; and transmitting the at least one data point to a data consumer having a second cryptographic private key, responsive to verifying a second record cryptographically associated with the first cryptographic private key and the second cryptographic private key.

The system of the present disclosure comprises: at least one embedded trusted device connected to the at least one data source, and a public transaction repository, wherein the at least one embedded trusted device stores a first cryptographic private key and is configured to receive at least one data point from the at least one data source and compute a digital signature of the at least one data point with the first cryptographic private key, wherein the public transaction repository is configured to contain at least a first record comprising the digital signature, and a second record cryptographically associated with the first cryptographic private key and with a second cryptographic private key of a data consumer.

The digital signature is generally cryptographically associated with the at least one data point. The cryptographic association is verifiable, wherein a verification only succeeds when the data point used for verification is the same data point used for computing the digital signature and when the cryptographic identity assumed for verification is the same cryptographic identity computing digital signature. These characteristics may typically be achieved by computing a cryptographic hash of the at least one data point, which may be the same cryptographic hash mentioned above or a separate, second cryptographic hash, and encrypting the computed cryptographic hash with a private key (by the signer), such that it can be decrypted with a corresponding public key (by the verifier).

The purpose of the cryptographic hash of the at least one data point is to create a verifiable link between different digital assets (for example, the at least one data point on the one hand and the identity of the embedded trusted device on the other hand), without disclosing either or both of them. This allows for a secure access scheme where, for example, a data provider owning the embedded trusted device can declare their consent to a third party accessing one or more data points identified by one or more cryptographic hashes. This declaration of consent may be implemented by a transaction on the public transaction repository. Someone else already having access to the one or more data points, such as the trusted network service described below in more detail, may then grant access to the third party according to the transaction accessible (for example publicly readable) on the public transaction repository. A further effect of this scheme is that the data consumer can stay anonymous while obtaining access to the data points and providing an incentive to the data provider. They do not need to reveal their identity to the data provider, which could be required for example in case of a direct connection between the data provider and data consumer for purposes of a private key exchange or other means for communicating a direct personal consent between the two parties.

When defining that the public transaction repository is configured to contain at least one second record cryptographically associated with the first cryptographic private key and with a second cryptographic private key of a data consumer, the cryptographic association referred to does not have to be direct. In general, also an indirect association is within the scope of the present disclosure. That is, the second record may comprise signatures of both cryptographic private keys. That would be the case, if there is a direct transaction between the data provider and data consumer. However, the present disclosure extends also to indirect or mediated or aggregated transactions, where intermediate parties take part in the transaction. For example, the data provider may have a transaction with a data aggregator, signed by those two parties. Then, there may be a separate transaction from the data aggregator to the data consumer, which is naturally signed by those two parties. In this example, the second transaction qualifies as a second record within the definition given above. It is signed by the data consumer, resulting in a direct association; and it is signed by the data aggregator, which in turn is associated with the first transaction, which is signed by the data provider, resulting in an indirect association. Notably, the data consumer may or may not (for privacy reasons) be able to trace the data point to a unique embedded trusted device, depending on the structure of the transactions involved.

The data source may be a data connection of the device or machine, the date of which shall be made available. For example, the data source may be a bus system of the device or machine, such as a Controller Area Network (CAN) bus of a vehicle or an Inter-Integrated Circuit (I2C) bus of an appliance controller or hardware monitor, such as an energy meter, a display, a speaker or a fan.

The public transaction repository may essentially be based on a distributed repository comprising a collection of records, such as those obtained by the method of the present disclosure. In general, the public transaction repository may also comprise other types of records. The records stored by the public transaction repository may have in common, that they are cryptographically verifiable and the public transaction repository provides the service of cryptographically verifying records before including them in the distributed repository. In addition, the public transaction repository provides enough information to users that they can verify the records stored by the public transaction repository. For example, the public transaction repository may be implemented with a blockchain. The term “public” defines that the records in the public transaction repository can be accessed and verified by parties other than the (two or more) participants of a particular transaction. The present disclosure is not limited to transaction repositories accessible to everyone. It also (but not exclusively) covers transaction repositories accessible only to participants in the disclosed systems or only (directly) to multiple distributed organizers and hosts of the transaction repository.

The embedded trusted device may be an embedded computing device comprising a computer, for example a single-board computer (SBC), e.g. of the Raspberry Pi or Arduino series. The embedded trusted device can act as a dongle. It may comprise a component usually referred to as “secure element” (or embedded secure element), that is, a hardware component comprising a memory for storing secret information. The secure element may adhere to the standards ISO 7816 and/or ISO 14443. The memory of the secure element is tamper protected, tamper resistant or “tamper-proof”, which is achieved by a dedicated hardware design and layout of the chip or silicon providing the memory. Conventional examples of secure elements are those used in smart cards (e.g. SIM cards or electronic payment cards). The secure element may for example comprise five pins as connectors; two of those pins, a serial data connector (SDA) and a serial clock connector (SCL) may be connected to communicate with the single-board computer via the inter-integrated circuit (I2C) bus and protocol. Optionally, the embedded trusted device may comprise a hardware secure enclave for RISC-V. This is to protect against unauthorised software modifications of the embedded trusted device and to provide traceable and verifiable information on the software running on a particular embedded trusted device. In one particular embodiment, the embedded trusted device may comprise or be connected to an on-board diagnostics (OBD) device, e.g. according to the OBD-II or EOBD or JOBD specifications. In addition, the embedded trusted device may have a mobile data connection providing an uplink to the public transaction repository and/or the trusted network service. The mobile data connection may be supported by a 5G communication network. Alternatively or additionally, embedded trusted device may participate in a mesh network, for example using LoRa communication links. The embedded trusted device may comprise an eSIM identity anchor using homomorphic encryption.

In one particular embodiment, the secure element of the embedded trusted device generates two pairs of cryptographic keys and stores them securely. One of the two key pairs represents a unique device identifier. The other key pair represents a unique identity and address on a second public transaction repository (e.g. the IPDB). It is impossible to extract the private keys from the secure element or otherwise gain knowledge thereof, due to hardware tamper protection measures of the secure element. Even the owner of the embedded trusted device does not know the private keys, but can only use them by means of operating their device or machine with the embedded trusted device. The private keys are stored encrypted within the secure element and never leave the secure element. They form part of the digital, cryptographic identity of the respective device. They are used for generating digital signatures, which digital signatures are therefore unambiguously associated with the respective embedded trusted device.

Consequently, when the at least one data point or data record is signed by the secure element, that means, that exactly this data is provably generated by the respective device. For example, a particular vehicle speed indicated in the first record is provably produced by the car comprising and connected to the particular embedded trusted device (proof of origin) and information of the vehicle speed as well as the particular time of reading its value from the data source can be verified (proof of integrity and authenticity). The verification can be performed with the public key, which is the corresponding public part of the key pair, to which the signing private key belongs. This public key can be publicly accessible and may also be part of the first record.

Of the two key pairs mentioned above, the first key pair used for signing the data may use the Elliptic Curve Digital Signature Algorithm (ECDSA) with the secp256k1-curve. This key pair may form the device identity. The other key pair may use the Edwards-curve Digital Signature Algorithm (EdDSA) with the twisted Montgomery curve (Ed25519). An IPDB transaction may comprise the complete first record as described above, including the signature and public key of the first key pair, and may further be signed with the private key of the second key pair.

Optionally, the method of the present disclosure comprises: transmitting the at least one data point and the digital signature to a trusted network service; and transmitting the at least one data point to a data consumer by the trusted network service. The trusted network service may comprise a private repository, for example implemented as a hosted cloud service, such as a hosted cloud storage service with fine grained access control. The data point may be encrypted prior to transmission to the trusted network service and/or it may be transmitted over a secure channel.

Correspondingly, the system may further comprise a trusted network service, wherein the trusted network service is configured to receive and store the at least one data point and the digital signature and the transmit the at least one data point to the data consumer.

The trusted network service controls access to the at least one data point. This control can be exercised dynamically and on a per-record level. This means that the same data consumer may be granted permission to access some data points while being refused access to other data points for same or different data sources. For example, the data consumer may be required to obtain repeated or continuous permission and consent by the data provider to access new data points. In this way, the present disclosure provides the technical basis for establishing continuous incentive for the data provider to share the data collected from their data source. Moreover, the trusted network service can provide more efficient access to data points from different data sources and even different data providers by providing a single interface. And it can relieve the data provider from providing continuous access to a potentially large number of data consumers.

In one embodiment of the present method, the method comprises: generating the first record by the trusted network service. Optionally, the method may further comprise transmitting the generated first record from the trusted network service to the public transaction repository. Correspondingly, the trusted network service of the present system may be configured to generate the first record. In this embodiment, the embedded trusted device needs only to communicate with a trusted network service, which takes care of the communication with the public transaction repository. This may be used to relieve the embedded trusted device from requirements that the public transaction repository may have for submitting entities. For example, the embedded trusted device may have to wait and monitor the acceptance of the first record by the public transaction repository in order to guarantee availability of the at least one data points to interested data consumers. Another example would be that the public transaction repository only accepts new records from sources undergoing a complicated and inflexible permission procedure. In that case it may be more efficient that the trusted network service obtains the permission to submit to the public transaction repository and acts as a gateway for embedded trusted devices, whose authenticity the trusted network service can guarantee (and continuously verify).

In this context, the present method may comprise: transmitting from the embedded trusted device an activation message to the trusted network service, wherein the activation message comprises a first public key associated with the first cryptographic private key and signed with a trusted provider private key. In other words, the activation message may comprise a certificate attesting to the identity and/or genuineness of the holder of the first cryptographic private key. In the present disclosure, this holder is the embedded trusted device.

Correspondingly, the embedded trusted device of the present system may be configured to transmit an activation message to the trusted network service, wherein the activation message comprises a first public key associated with the first cryptographic private key and signed with a trusted provider private key.

The activation message may serve the trusted network service as a means for controlling permissions for who can submit records to the trusted network service. For example, when a new record submitted, the trusted network service may be configured to verify the digital signature of the new record and whether the digital signature can be verified with a first public key that has previously been part of an activation message. The trusted network service may use an activation message as a trigger for creating a secure enclave within the trusted network service. A secure enclave comprises an encrypted memory that is inaccessible to a host system of the trusted network service. The trusted network service may comprise one or more secure enclaves, each uniquely associated with one embedded trusted device. For example, the secure enclaves may be implemented by using Intel Software Guard Extensions (SGX).

Further optionally, the present method may comprise: receiving by the embedded trusted device a data harvesting configuration, wherein the data harvesting configuration determines which data points are accessed from the connected data source. Correspondingly, the embedded trusted device of the present system may be configured to receive a data harvesting configuration, wherein the data harvesting configuration determines which data points are accessed from the connected data source. In general, the data source may provide a large spectrum of different types of data points, for example concerning multiple different parameters of a machine or device. Not all of these types of data points need to be shared or published or provided for external data consumers. Some types of data points may be undisclosed by the manufacturer of the machine or device, e.g. for reasons of protecting the know-how. Some types of data points may be withheld by the owner of the machine or device, the data provider, for business or privacy reasons. Finally, some types of data points may simply be of little value to third parties. The data harvesting configuration may for example define a limited set of types of data points that the embedded trusted device is ready to receive from a connected data source. According to another example, the data harvesting configuration may comprise one or more data extraction scripts, which contain instructions enabling the trusted embedded device to retrieve one or more data points from the data source. Moreover, the data harvesting configuration may contain and configure conditions for uploading data points from the embedded trusted device (e.g. within a car) to a trusted network service (e.g. a cloud data enclave). Finally, the data harvesting configuration may also comprise metadata related to the configured types of data points, such as the title, description or price range accepted by the data provider.

In one particular embodiment, when the data harvesting configuration is for an embedded trusted device used in a car, it may contain so-called PID-Information, comprising parameters for interpreting messages on the CAN bus and a mapping table for interpreting message identifiers on the CAN bus, for example on-board diagnostics Parameter IDs (OBD-II PIDs) and/or CAN bus database (DBC) tables for translating the CAN data into human readable data including the eventual processing methods needed to do so. An example for such a diagnostic parameter would be the vehicle speed of a car when the last diagnostic trouble code was set. In general, the system may be able to retrieve any kind of CAN data, since it supports a process where the OEM (e.g. Daimler) defines themselves the ways to extract data from the vehicle, by adding information like PIDs for filtering the desired CAN data from the bus data flow.

The data harvesting configuration may be encrypted for decryption with the first cryptographic private key. For example, the data harvesting configuration may be in an encrypted JSON format. The encryption protects the contents of the data harvesting configuration from users outside the embedded trusted device. For example, the data harvesting configuration may contain secrets related to the data source, such as credentials for accessing the data source or protected know-how for interfacing with the data source. Optionally, the content of the data how the configuration may be protected within a local enclave accessible only through the secure element.

In one particular example, the data source may be a bus system of the device or machine and the data harvesting configuration comprises parameter or message identifiers for filtering or subscribing to messages transmitted over the bus system according to those identifiers. Optionally, the data harvesting configuration may also comprise information needed for decoding messages received from the data source, such as the bus system. This information may for example described how the binary information of a digital message on the bus system shall be interpreted to obtain a numeric value of a particular parameter. The data harvesting configurations may also comprise a cryptographic decryption key needed for intercepting encrypted messages on the bus system or generally received from the data source. Further optionally, the harvesting configuration may comprise information on how to authenticate data points received from the data source, for example a public key for verifying a digital signature or a salt for verifying a salted hash.

Optionally, the data harvesting configuration may comprise one or more computations scripts. A computation script may comprise instructions enabling the embedded trusted device to compute the at least one data point from unprocessed data received or retrieved from the data source. The computation script may also be used to modify the at least one data point received from the connected data source. For example, a computation script may be used to determine derived parameters as additional data point types. Or it may be used to perform normalisation or calibration of the at least one data point before it leaves the embedded trusted device. In particular, a computation script may be used to perform intermediary statistical evaluations at this stage of the embedded trusted device to reduce the amount of potentially private information contained in the shared data points. The computation strip may also be used to compute combined data points, which are a function of multiple data point received from the data source. Also, a computation script may be used to perform classification of data points received from the connected data source, such that only a class or category of a particular parameter is published or shared. In particular, these types of computations may precede the computation of the digital signature. The digital signature can therefore attest to the authenticity and integrity of the computed data points- and, implicitly, of the computation scripts—determined by applying the one or more computations scripts to the at least one data point received from the connected data source.

In one specific embodiment of the present disclosure, the public transaction repository may be a distributed ledger, in particular a permissioned blockchain. In particular, the public transaction repository may be configured to accept only records including a digital signature by a permitted embedded trusted device. The permission of the embedded trusted device to submit records to the public transaction repository may be based on a cryptographic certificate. For example, the first cryptographic private key may have a corresponding first public key, which is signed by a trusted provider private key. The configuration of the public transaction repository comprises a trusted provider public key and the public transaction repository is configured to verify digital signatures of submitted records and accept only records having a digital signature that can be verified with a cryptographic certificate that itself can be verified with the trusted provider public key. The invention is not limited to this particular implementation of a cryptographic chain of trust, but extends to other schemes serving the same purpose. For example, the public transaction repository may have a list of first public keys and accepts all records with digital signatures that can be verified with any of the first public keys on this list. The list may be part of the configuration of the public transaction repository or it may be managed on the public transaction repository itself. Generally, the use of a permissioned blockchain serves to attest to the authenticity of the data points by ensuring that any records on the public transaction repository have their origin at an embedded trusted device having a trusted link to the configuration of the public transaction repository. In other words, data consumers can verify cryptographically that any data points accessible through the public transaction repository have been submitted through an embedded trusted device, which is trusted by the operators of the public transaction repository. For example, this may mean, that the operators or at least one of the operators has verified the source or configuration of the embedded trusted device; or the embedded trusted device has been installed and connected to an authentic data source under the control and supervision of one of the operators of the public transaction repository.

Generally, the invention also concerns the embedded trusted device contribute are prepared for use in a method or a system as disclosed above. That is, also in a state, where the embedded trusted device is not yet installed and connected to a data source, but prepared to being connected to a data source upon installing by a third party. Specifically, the embedded trusted device may be configured to communicate with a public transaction repository and with a trusted network service as disclosed above, wherein the embedded trusted device may be configured to transmit different, for example more, information to the trusted network service than to the public transaction repository. More in detail, the embedded trusted device may be configured to transmit at least one data point received from a data source to the trusted network service and to transmit only an information uniquely identifying—but not containing—the at least one data point, for example a cryptographic hash, to the public transaction repository. The public transaction repository may subsequently include the cryptographic hash of the at least one data point. Not storing the at least one data point itself on the public transaction repository, that is, neither directly nor in encrypted form, can help to keep the amount of data on the public transaction repository (the “chain”) smaller. This is often a welcome effect for distributed data that is stored redundantly by many parties or participants of the public transaction repository.

Within the present disclosure and in particular with respect to the claims, when a method is defined as comprising multiple steps or actions, the meaning of the method is not limited to the order in which the steps are listed in writing. Instead, the scope of the present disclosure extends to any order of steps as possible while respecting potential dependencies between the steps, e.g. when a result of one step is one of the inputs of a later (but not necessarily next) step.

Referring now to the drawings, wherein the figures are for purposes of illustrating the present disclosure and not for purposes of limiting the same:

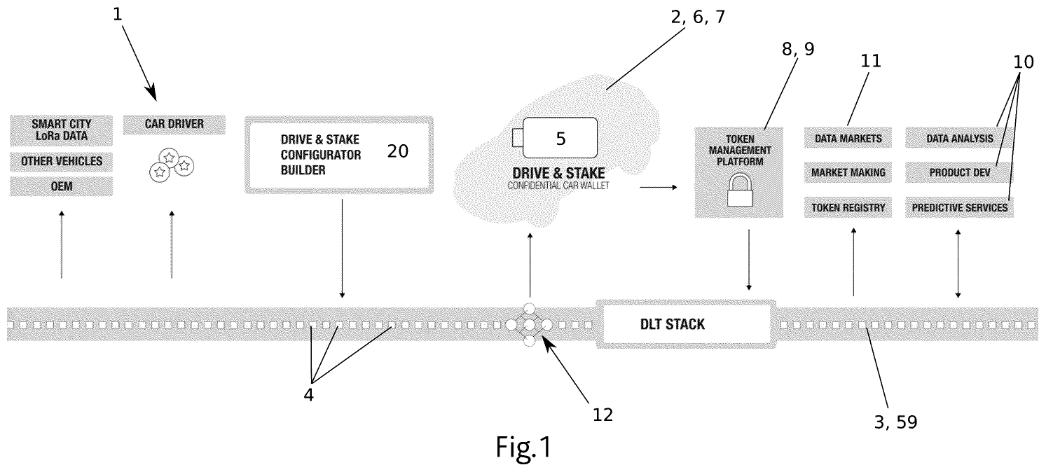

FIG. 1 schematically shows a system according to the present disclosure and how the public transaction repository implemented as a distributed ledger connects the other components and outside participants;

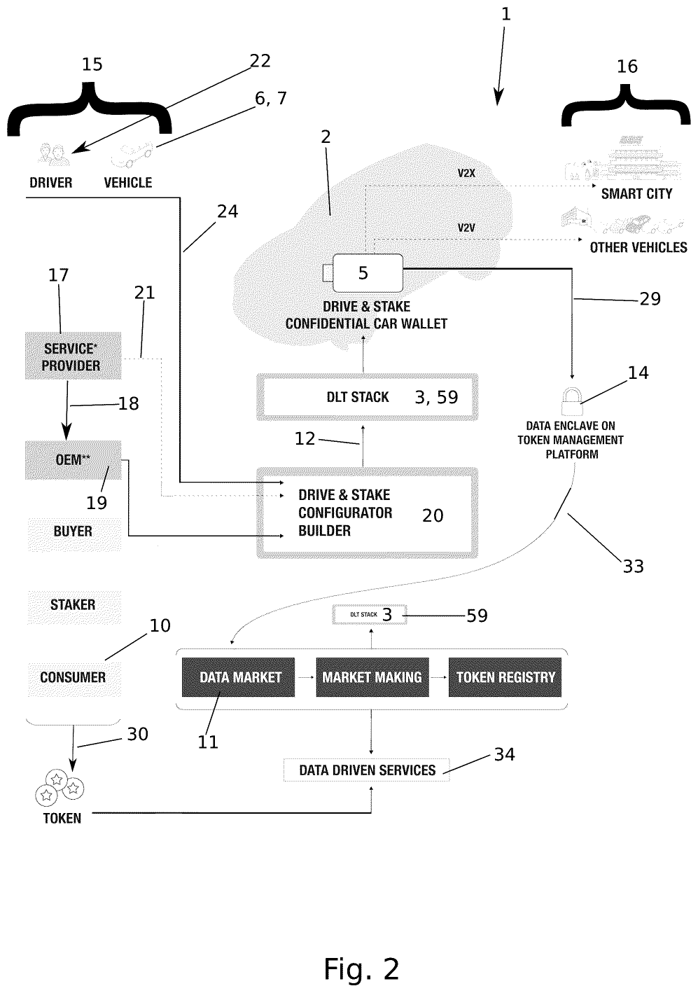

FIG. 2 schematically shows the data flow through the components of the system according to FIG. 1;

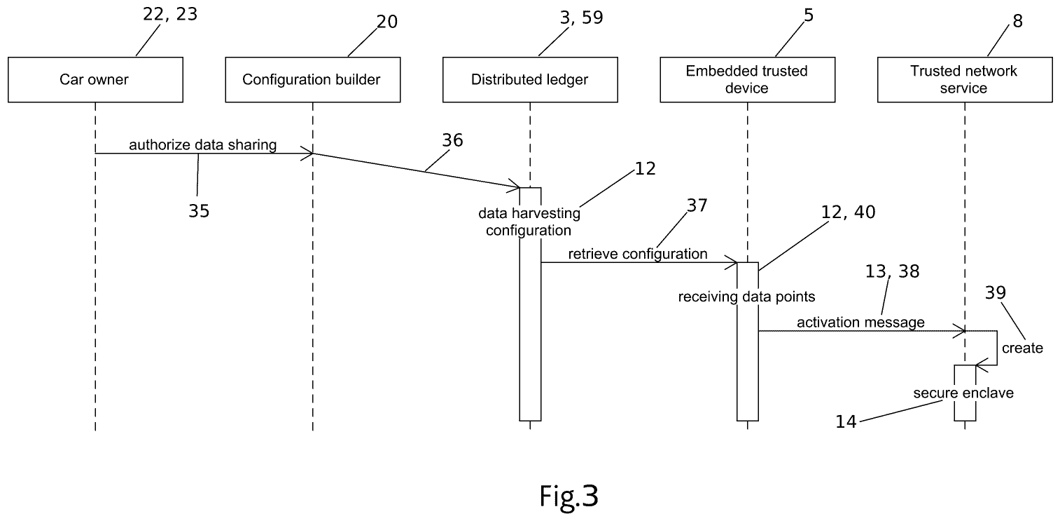

FIG. 3 shows a sequence diagram of an initialisation and activation of an embedded trusted device and a secure enclave for one particular embodiment;

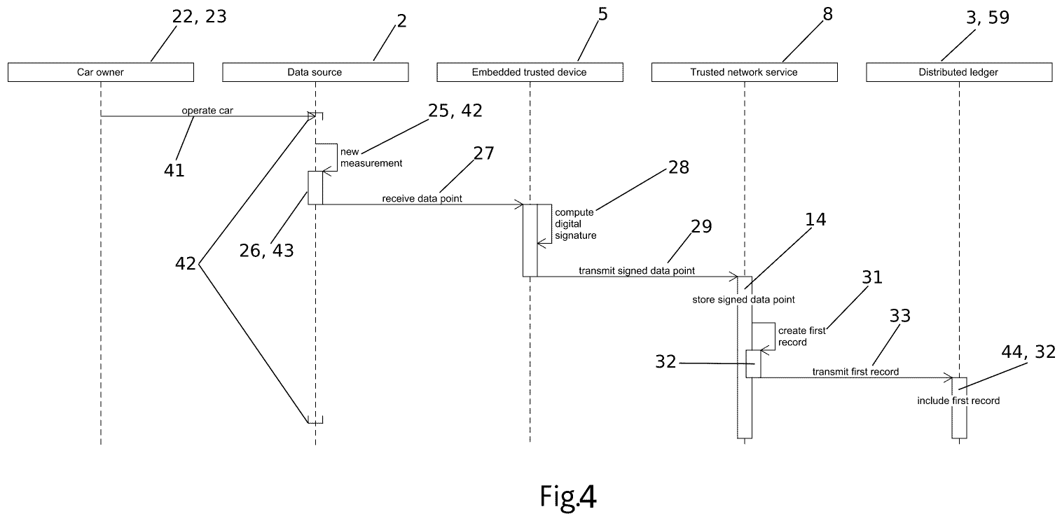

FIG. 4 shows a sequence diagram of the method according to the present disclosure for sharing at least one data point within the same particular embodiment as FIG. 3; and

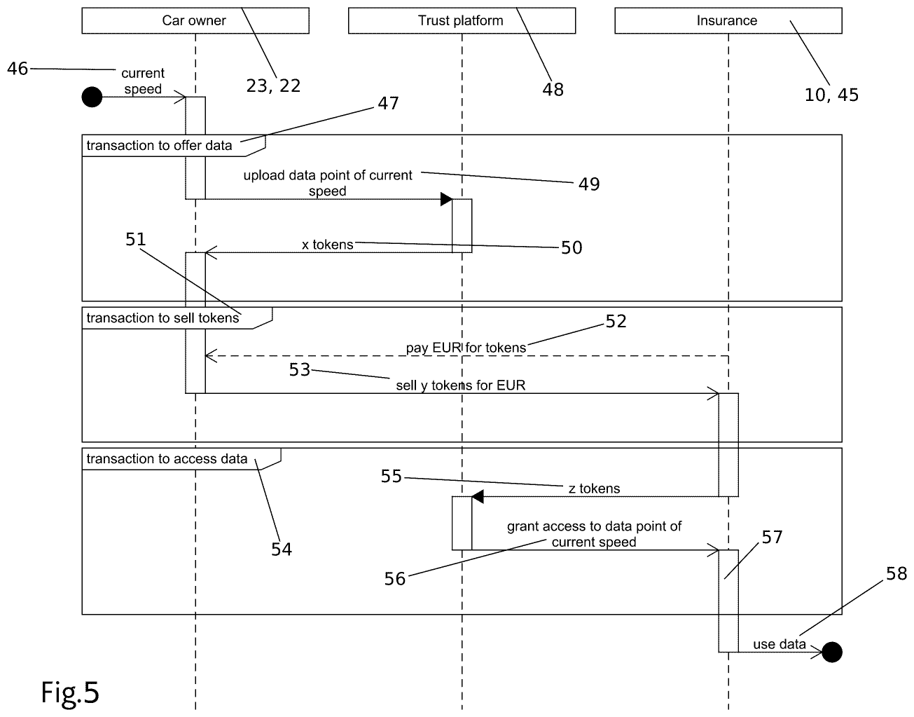

FIG. 5 shows a simplified sequence diagram illustrating an exemplary use of the present disclosure, applied to the same particular embodiment as FIGS. 3 and 4.

FIG. 1 shows a system 1 for securely distributing data generated by at least one data source 2. The system 1 comprises a public transaction repository 59 implemented as a distributed ledger 3 graphically illustrated as a chain of blocks 4. To indicate that the distributed ledger 3 is more than the storage of those blocks 4, that is, a repository, it is also referred to as DLT stack (distributed ledger technology stack). The term stack refers to the presence of additional vertical services, such as database systems providing the storage, interfaces and modules for interacting with the distributed ledger 3 and—more precisely-its participants.

The system 1 further comprises an embedded trusted device 5. In the example in FIG. 1, the embedded trusted device 5 is indicated as a hardware component with an on-board diagnostics interface (e.g. according to the OBD-II specification). The embedded trusted device 5 is schematically shown to be part of a larger device or machine 6, in this case a car 7. The on-board bus system of the car (typically a CAN bus system) is the data source 2 of the present system 1. The embedded trusted device 5 is connected to this bus system and, hence, to the data source 2.

The embedded trusted device 5 stores a first cryptographic private key. More specifically, the first cryptographic private key is generated and stored by an embedded secure element forming part of the embedded trusted device 5. The embedded secure element creates an indisputable identity. The embedded trusted device 5 is configured to receive at least one data point from the data source 2 and compute a digital signature of the at least one data point with the first cryptographic private key. Specifically, the embedded secure element 5 reads and signs for example car, environment, smart city and driver-related data and attests it on the distributed ledger 3 (e.g. a blockchain). The identity created by the embedded secure element guarantees the origin and integrity of the data.

The system 1 further comprises a trusted network service 8, which in the example of FIG. 1 is implemented by a token management platform 9. The trusted network service 8 is configured to receive and store the at least one data point and the digital signature. The trusted network service 8 is configured to generate a first record comprising the digital signature and to submit it to the distributed ledger 3. The distributed ledger 3 is a permissioned blockchain. Following the submission by the trusted network service 8, the distributed ledger 3 authenticates the submitter and verifies their permission to submit records to the distributed ledger 3. After acceptance, the distributed ledger 3 contains the first record. Effectively, the token management platform 9 tokenizes the data received from the embedded trusted device 5.

The trusted network service 8 is configured to transmit the at least one data point to a data consumer 10. Specifically, the token management platform 9 makes the received data available on decentralised and automated data markets 11, where it can be analysed, enhanced, traded or used to develop new products and services. In order for a data consumer 10 or market participant to access the at least one data point, the distributed ledger 3 further contains a second record cryptographically associated with the first cryptographic private key and with a second cryptographic private key of a data consumer. The trusted network service 8 relies on the existence of such a second record before granting the data consumer 10 access to the at least one data point.

For preparing the embedded trusted device 5 for subsequent data collection, it is configured to receive a data harvesting configuration 12. The data harvesting configuration 12 can be retrieved from the distributed ledger 3. The data harvesting configuration 12 determines which data points are accessed from the connected data source 2.

For preparing the trusted network service 8, the embedded trusted device 5 is configured to transmit an activation message 13 (see FIG. 3) to the trusted network service 8. The activation message 13 comprises a first public key associated with the first cryptographic private key and signed with a trusted provider private key. Based on this information, the trusted network service 8 authenticates the embedded trusted device 5 and prepares a secure enclave 14 for receiving and storing data points in a secure manner.

FIG. 2 shows methods for preparing an embedded trusted device 5 and for securely distributing data collected by an embedded trusted device 5. The left side in FIG. 2 indicates the actors 15 of the system 1 as shown in FIG. 1. The top right corner of FIG. 2 indicates interfaces to external systems 16, with which the present system 1 may be integrated to form a wider ecosystem of data exchange. The remaining parts of FIG. 2 are dedicated to the system 1 itself and its internal interactions.

In chronological order, the methods illustrated in FIG. 2 may set out with a service provider 17 requesting access to certain types of data points. The service provider 17 may for example be a fleet manager, a car rental, an insurance company or a provider of electric charging stations. The service provider 17 sends a request 18 for data access to an original equipment manufacturer (OEM) 19, for example, a car manufacturer. The OEM 19, based on the data types requested by the service provider 17, cooperates with a configuration builder 20 to prepare a data harvesting configuration 12 (also called “Drive & Stake configuration file” or “DSC”). Specifically, the OEM 19 provides the configuration builder 20 with the information and parameters needed to extract the desired data points from the data source 2. The configuration builder 20, based on this information and parameters, prepares a data harvesting configuration 12 and attests to the authenticity and integrity of the data harvesting configuration 12 by encrypting it with a public key corresponding to the first cryptographic private key of the embedded trusted device 5 connected to the data source 2. For that purpose, the configuration builder 20 has an archive of public keys matching one or more embedded trusted devices rolled out. The data harvesting configuration 12 determines which data points shall be accessed from the data source 2 connected to the embedded trusted device 5, that is, once the data harvesting configuration 12 is received, accepted and installed on the embedded trusted device 5.

In an alternative indicated by a dashed line 21 in FIG. 2, the service provider may request the preparation of a data harvesting configuration 12 directly from the configuration builder 20. This alternative may be feasible, if the configuration builder 20 does not need any additional information from the OEM 19. For example, in case the configuration builder 20 already has sufficient information on how the embedded trusted device 5 may access the desired type of data points.

Once the configuration builder 20 is ready to deploy a data harvesting configuration 12, it can provide this option to data providers 22 owning capable data sources 2, that is, data sources capable of providing the type of data points requested by the service provider 17. When a data provider 22, such as the owner or driver 23 of a car 7, agrees and authorises the data sharing of the particular type of data points, they send a confirmation and approval 24 to the configuration builder 20. Thereby, they effectively authorise the use of the configuration on one or more embedded trusted devices 5 in their ownership. Based on this approval, the configuration builder 20 submits a suitable data harvesting configuration 12 to the DLT stack 3.

Next, the embedded trusted device 5 needs to receive the data harvesting configuration 12. The embedded trusted device 5 may either monitor the DLT stack 3 for changes such as the one described above or it may be notified by a service within the DLT stack 3 of a relevant change and the availability of a new data harvesting configuration. For example, when the embedded trusted device 5 is deployed in a car 7, it may be configured to receive an updated data harvesting configuration 12 whenever the car 7 is started. In either case, the embedded trusted device 5 retrieves the new data harvesting configuration 12 from the DTL stack 3 and installs this configuration and thereby activates collection of the type of data points requested by the service provider 17.

When the embedded trusted device 5 is first used or for the first time configured for collecting the particular type of data points, it transmits an activation message 13 to the trusted network service 8. The activation message 13 comprises a first public key associated with the first cryptographic private key of the embedded trusted device 5. The first public key uniquely identifies the embedded trusted device 5. The embedded trusted device 5 may also be identified by an address deterministically generated from the first public key. The first public key is signed with a trusted provider private key. The combination of the public key and the signature forms a certificate. The certificate authority is the trusted provider controlling the trusted provider private key. The trusted network service 8 is either itself the certificate authority or comprises a list of trusted certificate authorities. In either case, it can verify the signature of the public key and thereby the validity of the certificate provided with the activation message 13. If the validity is confirmed, the trusted network service 8 confirms to accept data points from the embedded trusted device 5 transmitting the activation message 13. This confirmation may be submitted to the distributed ledger 3 for publication and transparency. It may serve as a basis for preparing and securing a secure data enclave 14 within the trusted network service 8, which will hold and protect future data points transmitted from the embedded trusted device 5 to the trusted network service 8.

Whenever the data source 2 generates 25 (see also FIG. 4) a data point 26 matching the data harvesting configuration 12, the embedded trusted device 5 receives 27 the data point from the connected data source 2. The embedded trusted device 5 then computes 28 a cryptographic hash and a digital signature of the received data point. For computing the digital signature, the embedded trusted device 5 uses the first cryptographic private key stored in the embedded trusted device 5. The at least one data point and the digital signature are then transmitted 29 to the trusted network service 8. In the present example, the embedded trusted device 5 transmits 29 an encrypted and signed version of the data point to a token management platform 9 of the trusted network service 7.

As shown in FIG. 2, the trusted network service 8 comprises a token management platform 9 and provides a data enclave 14 specifically for data points received from a particular embedded trusted device 5. The trusted network service 8 exposes the available data point on a data market 11, for example by associating the data point with a digital token 30. The data market 11 may be connected for example via the Ocean Protocol. Specifically, the trusted network service 8 generates 31 a first record 32 comprising at least the cryptographic hash or the digital signature and transmits 33 the first record to the distributed ledger 3. Third parties interested in accessing the data point can obtain exchangeable tokens 30 for example from one of the other actors, such as the data provider 22 or the OEM 19, and exchange those tokens 30 for access to the data point or a collection of data points by submitting a corresponding transaction on the distributed ledger 3. With a suitable supply of tokens 30, this system 1 enables data driven services 34 while providing incentives to data providers 22 to share data points available through their respective data sources 2, either to sell tokens 30 for money or to enjoy access to the data driven services 34.

The method comprises transmitting the at least one data point to a data consumer 10. The data consumer 10 needs to have a second cryptographic private key and there must be a second record on the distributed ledger 3. The at least one data point is only transmitted to the data consumer 10 responsive to verifying the second record cryptographically associated with the first cryptographic private key and the second cryptographic private key. As discussed in detail in the introduction, the association of the second record with each of the cryptographic private keys may be direct or indirect. In the present example, the second record is used as a proof of authorisation for accessing the contents of the data enclave 13 provided by the trusted network service 8 and token management platform 9. Only when the distributed ledger 3 contains a verifiable chain of transactions from the identity of the embedded trusted device 5 to the identity of the data consumer 10, which transactions are further associated with one or more data points through cryptographic hashes and/or digital signatures, will read access to the associated one or more data points be granted to the data consumer 10 or a data driven service 34. In particular, the at least one data point will then be transmitted to the data consumer 10 by the trusted network service 8. For example, the data or access to the data may be delivered by means of a link to a data enclave 14, which data enclave contains the respective data.

By providing access to the shared data via data markets 11 automatically provided by the token management platform 9, the data provider 22, for example a car driver, enables specific services, such as specific driver services, with the help of confidential and trusted data that comes with a proof of origin. In this example, the driver can use the tokens 30 collected in exchange for providing data points for staking (i.e., keeping and locking funds of the tokens in a wallet to support the security and operations of the underlying blockchain network) or for consuming third-party data driven services 34 or exchange those tokens 30 for a currency.

In participating in the present system, OEMs have the advantage to unlock and access consumer data in a controlled and auditable way, making it easier for them to access and use this data in a GDPR-compliant way, ensuring data sovereignty, and without revealing industry secrets.

In one specific example of an application, a car rental company (the service provider) requests from Daimler (the OEM) the tyre pressure state of their vehicles in Germany every 24 hours and desires to market these data to an Ocean Protocol data market. Daimler will then build a DSC file with the following content: the PID code for retrieving the tyre pressure from the CAN bus, the DBC information for translating the binary CAN data into PSI or bar values, the condition that a geolocation is Germany, the condition that a reporting frequency is 24 hours, and that the targeted data market is the Ocean Protocol. The driver or owner of the car accepts the data sharing of the vehicle information requested by the system. Then, the built DSC file will be encrypted and sent to a cloud enclave and signed on the blockchain. The Daimler vehicles in Germany of the car rental company (i.e. for which the configuration has been approved) will retrieve the DSC configuration file from the cloud enclave with their respective embedded trusted devices. The embedded trusted devices will confidentially decrypt the DSC file for capturing the tyre pressure data by using the PID codes, using the DBC table to process and translate the data into Psi or bar, encrypt the captured CAN data and send them to the data enclave by signing the data on the blockchain. The data enclave will then use the data market information to publish the data to the Ocean data market (tokenization process with a tokenized access link to the data).

The individual steps and actions performed for preparing the embedded trusted device 5 and the trusted network service 8 for data collection are illustrated as a sequence diagram in FIG. 3. In general, these steps have already been described in relation to FIG. 2 and both figures and the respective description are intended to complement each other. The sequence shown in FIG. 3 starts when the configuration builder 20 has already prepared at least one configuration that can be used by the data provider—in this example a car owner 23. When the car owner 23 decides that they want to put the data generated by their car 7 to additional use, they authenticate themselves at the configuration builder 20. The car owner 23 may receive credentials for this authentication from the OEM 18 of the car 7, for example upon purchase of the car 7. Alternatively, the car owner 23 may obtain suitable credentials via an OEM-specific platform the car owner 23 has been registered with, for example upon purchase of the car 7. Such OEM-specific platforms are typically already used for providing information and access to functions of the car via similarly OEM-specific mobile apps. Irrespective of how the credentials for use with the configuration builder 20 are obtained, they are already linked to the identity of the embedded trusted device 5 rolled out in the car 7 of the car owner 23. Through this link the configuration builder 20 can obtain the identity of the embedded trusted device 5. When the car owner 23 authorises 35 a particular data harvesting configuration 12, the configuration builder 20 encrypts the authorised configuration for the identity of the embedded trusted device 5, that is, such that the embedded trusted device 5 can decrypt the authorised configuration. Then it signs the encrypted configuration and submits 36 it to the distributed ledger 3 with a link to the identity of the embedded trusted device 5. The distributed ledger 3 verifies the source of the encrypted configuration being an authorised configuration builder 20 and upon successful verification accepts the submitted configuration. The next time the car owner 23 starts their car 7, the embedded trusted device 5 accesses the distributed ledger 3 and retrieves 37 the new configuration. It decrypts the data harvesting configuration 12 installs and activates it within the embedded trusted device 5. Thereby, the embedded trusted device 5 is prepared for receiving data points from the connected data source 2. At the same time or before the first data points shall be shared, the embedded trusted device 5 transmits 38 an activation message 13 to the trusted network service 8. The activation message 13 instructs the trusted network service 8 that the embedded trusted device 5 sending the activation message 13 intends to participate in data sharing and to transmit collected data points. In reaction to the activation message 13, the trusted network service creates 39 a secure enclave 14 for storing the data point received from the particular embedded trusted device 5 from which the activation message 13 has been received. The secure enclave 14 is cryptographically bound to the identity of this embedded trusted device 5. At the end of the sequence illustrated in FIG. 3, the distributed ledger 3 holds a data harvesting configuration 12 applicable to the embedded trusted device 5 of the car owner 23 who authorised data sharing; the embedded trusted device 5 is in an operating mode 40 where it accepts data points incoming from the data source 2 and receives those data points when they arrive; the trusted network service 8 hosts a secure enclave 14 associated with the embedded trusted device 5 ready to receive and store data points collected and forwarded by the embedded trusted device 5.

The individual steps and actions performed for collecting and securely distributing a new data point according to the present disclosure are illustrated as a sequence diagram in FIG. 4. Also these steps have been described in relation to FIG. 2 and again both figures and the respective description are intended to complement each other. The sequence shown in FIG. 4 starts when the car owner 23—for example the same car owner FIG. 3—starts to operate 41 their car 7. During operation 42, for example a sensor within the car 7 produces 42 a new measurement 43. The new measurement 43 is submitted to the CAN bus of a car 7, which serves as a data source 2. The embedded trusted device 5 is connected to the CAN bus and has previously been configured by a suitable data harvesting integration 12 to accept data points of the type used for new measurements of that particular sensor. Consequently, the embedded trusted device 5 receives 27 the new data point. Receiving means that the embedded trusted device 5 reads the corresponding message from the CAN bus and performs all interpretation and conversion steps as defined in the data harvesting configuration 12. It then computes 28 a digital signature of a payload including the new data point. The digital signature is computed with the first cryptographic private key stored in a secure element of the embedded trusted device 5, thereby attesting to the origin of the signed data point. The embedded trusted device 5 then transmits 29 the signed data point (and potentially additional information defined in the data harvesting configuration 12, for example concerning marketing instructions or restrictions for data points of this particular type) to the trusted network service 8 that has previously been activated, for example according to FIG. 3. For transmission, the signed data point is encrypted with a public key of the trusted network service 8. The trusted network service 8 decrypts the signed data point and stores the received signed data point in the prepared secure enclave 14. It then creates 31 a first record 32 for submission to the distributed ledger 3. The first record 32 is signed by a cryptographic private key of the trusted network service 8. It also contains a cryptographic link to the data point 26, for example a cryptographic hash of the data point. It does not contain the data point 26 itself. Also, the first record 32 may avoid tracing the data point 26 back to its origin, a uniquely identifiable embedded trusted device 5, depending on the data harvesting configuration 12 authorised by the car owner 23 and data provider 22. The distributed ledger 3 verifies the origin of the first record 32, that is the trusted network service, and upon successful verification includes 44 the submitted first record 32. At the end of the sequence illustrated in FIG. 4, the secure enclave 14 hosted by the trusted network service 8 stores an additional signed data point (in general, the secure enclave may also store data points without the digital signature); and the distributed ledger 3 contains a first record 32 with a cryptographic link, which can be securely traced to the secure enclave 14 and the data point 26 stored within the secure enclave 14.

FIG. 5 shows a schematic sequence diagram to provide an overview of some possible different transactions until a particular data point finds its way from its origin in the control of the data provider 22 (for the purposes of this example, a car owner 23) to a data consumer 10 (for the purposes of this example, a car insurance company 45). The data point, for example the current speed 46 of a vehicle, enters into existence under the control of the car owner 23 operating their car 7. The first transaction 47 is that of offering the data point for sharing with third parties. This transaction 47 is between the car owner 23 and a trust platform 48 hosting a trusted network service 8. The car owner 23 or, more precisely, the embedded trusted device 5 operating within their car 7, uploads 49 the data point containing the current speed 46 to the trust platform 48 or, more precisely the trusted network service 8. In exchange 50, the trust platform 48 issues a certain amount of digital tokens 30, which amount may depend on the type of the data point and/or marketing conditions defined by the data provider 22 in the applicable data harvesting configuration 12. The digital tokens 30 may be transferred to the car owner 23 by means of a record on a distributed ledger 3. The distributed ledger 3 may be hosted by and form part of the trust platform 48, for example a permissioned blockchain, or it may be an independent and optionally application-agnostic distributed ledger interfaced by the trust platform 48, for example a public blockchain or a side-chain to a public blockchain. For the present example it is assumed that the car owner 23 does not want to exchange their newly obtained digital tokens 30 for data driven services 34 that may be offered by third parties. They then have the choice to trade their digital tokens 30 for a fiat currency (e.g. EUR) on a public marketplace. The insurance company 45 is interested in collecting data on the speed of vehicles of the types operated by the car owner 27. In order to obtain access to such data, they place an offer to buy 52 suitable digital tokens 30 in the same public marketplace. The second transaction 51 shown in FIG. 5 is thus a deal between the car owner 23 and the insurance company 45 to exchange digital tokens 30 for fiat currency. The car owner 23 fulfils 53 the deal by submitting a new record to the distributed ledger 3, transferring their digital tokens 30 to (a wallet of) the insurance company 45. The digital tokens 30 are independent of the actual data point shared by the car owner 23. Nevertheless, for the simplicity of this example, it is assumed that in the third transaction 54, the insurance company 45 exchanges the digital tokens 30 bought in the public marketplace for access to the data point of the current speed. This transaction 54 is between the trust platform 48 and the insurance company 45. This time, the insurance company submits 55 to the distributed ledger 3 a transaction transferring a certain amount of the digital tokens 30 to the trust platform 9. The trust platform 9 verifies the transaction and upon successful verification grants 56 the insurance company 45 access to the data point originally shared by the car owner 23. For example, it may send the insurance company 45 a link to access the data point within a secure enclave 14 hosted by a trusted network service 8. Via the link, the insurance company 45 may for example download 57 the data point and subsequently use 58 the data in their evaluations.

1. A method for securely distributing data collected by an embedded trusted device, the method comprising:
receiving by the embedded trusted device at least one data point from a connected data source;
computing a cryptographic hash of the at least one data point;
computing by the embedded trusted device a digital signature of the at least one data point with a first cryptographic private key stored in the embedded trusted device;
transmitting a first record comprising at least the cryptographic hash or the digital signature to a public transaction repository;
transmitting the at least one data point to a data consumer having a second cryptographic private key, responsive to verifying a second record cryptographically associated with the first cryptographic private key and the second cryptographic private key.

2. The method of claim 1, wherein the method comprises:
transmitting the at least one data point and the digital signature to a trusted network service;
transmitting the at least one data point to a data consumer by the trusted network service.

3. The method of claim 2, wherein the method comprises:
generating the first record by the trusted network service.

4. The method of claim 2, wherein the method comprises:
transmitting from the embedded trusted device an activation message to the trusted network service,
wherein the activation message comprises a first public key associated with the first cryptographic private key and signed with a trusted provider private key.

5. The method of claim 1, wherein the method comprises:
receiving by the embedded trusted device a data harvesting configuration;
wherein the data harvesting configuration determines, which data points are accessed from the connected data source.

6. The method of claim 5, wherein the data harvesting configuration is encrypted for decryption with the first cryptographic private key.

7. The method of claim 1, wherein the public transaction repository is a distributed ledger.

8. A system for securely distributing data generated by at least one data source, the system comprising:
at least one embedded trusted device connected to the at least one data source, and
a public transaction repository,
wherein the at least one embedded trusted device stores a first cryptographic private key and is configured to receive at least one data point from the at least one data source and compute a digital signature of the at least one data point with the first cryptographic private key,
wherein the public transaction repository is configured to contain at least a first record comprising the digital signature, and a second record cryptographically associated with the first cryptographic private key and with a second cryptographic private key of a data consumer.

9. The system of claim 8, wherein the system further comprises a trusted network service,
wherein the trusted network service is configured to receive and store the at least one data point and the digital signature and to transmit the at least one data point to the data consumer.

10. The system of claim 9, wherein the trusted network service is configured to generate the first record.

11. The system of claim 9, wherein the embedded trusted device is configured to transmit an activation message to the trusted network service,
wherein the activation message comprises a first public key associated with the first cryptographic private key and signed with a trusted provider private key.

12. The system of claim 8, wherein the embedded trusted device is configured to receive a data harvesting configuration,
wherein the data harvesting configuration determines which data points are accessed from the connected data source.

13. The system of claim 12, wherein the data harvesting configuration is encrypted for decryption with the first cryptographic private key.

14. The system of claim 8, wherein the public transaction repository is a distributed ledger.

15. The method of claim 7, wherein the distributed ledger is a permissioned blockchain.

16. The system of claim 14, wherein the distributed ledger is a permissioned blockchain.
